(19) United States
(12) Patent Application Publication
(10) Pub. No.: US 2014/0270206 A1
(43) Pub. Date: Sep. 18, 2014

(54) ACOUSTIC TRANSMISSIVITY IMPAIRMENT DETERMINING METHOD AND APPARATUS

(71) Applicant: Timothy Alan PORT, Kingsford (AU)

(72) Inventor: Timothy Alan PORT, Kingsford (AU)

(21) Appl. No.: 14/208,658

(22) Filed: Mar. 13, 2014

Related U.S. Application Data
(60) Provisional application No. 61/789,796, filed on Mar. 15, 2013.

(51) Int. Cl. H04R 29/00

(52) U.S. Cl. CPC H04R 29/004
USPC 381/58

(57) ABSTRACT

A method of determining an extent of impairment of acoustic transmissivity of a structural arrangement exposing a microphone, the method including receiving first and second responses generated by the microphone responsive to received acoustic energy and ascertaining the extent of impairment based on the first and second responses.

### CROSS-REFERENCE TO RELATED APPLICATIONS

This application claims priority to U.S. Provisional Patent Application No. 61/789,796, by the same title as captioned above, naming Timothy Alan Port as an inventor, filed on Mar. 15, 2013, in the USPTO, the entire contents of that application being incorporated herein by reference in its entirety.

### BACKGROUND

1. Field of the Invention

The present technology relates generally to technologies for determining an extent of impairment of acoustic transmissivity of a structural arrangement exposing a microphone of an audio-processing device, e.g., an auditory prosthesis, to incident sound waves.

2. Related Art

A microphone-based audio-processing device includes one or more microphones that are used to convert incident, e.g., ambient, sound waves into electrical signals. The audio-processing device processes the electrical signals in some manner, e.g., amplification, filtering, etc., and provides the processed signals to a user of the audio-processing device in one or more formats, e.g., as acoustical stimulation (via the generation of sound waves), as electrical stimulation, mechanical stimulation, etc. Some audio-processing devices are used to help persons suffering from hearing loss.

If the acoustical path that leads a sound wave to the microphone of an audio-processing device becomes impaired, e.g., by the accumulation of debris, the performance of the microphone, and thus of the audio-processing device, diminishes. The degree to which the performance of the microphone diminishes is related to the degree to which acoustic path is impaired by debris.

For the auditory prosthesis variety of audio-processing device, the one or more microphones included therewith are typically located near the ear of the recipient, which exposes the microphones to debris and moisture. Typically, the one or more microphones of an auditory prosthesis are provided with structural arrangements intended to protect the microphones from debris and moisture, e.g., port or cover arrangements. In anticipation of the acoustic path becoming impaired by debris, manufacturers of auditory prosthesis typically recommend that the recipient visit a clinician (someone having the requisite training and equipment) according to a schedule, e.g., once every three months, so that the clinician may determine if the acoustic paths to the microphones are impaired to an extent that warrants replacement of, e.g., the covers. In lieu of visiting the clinician to check for impairment of the acoustical path, manufacturers typically recommend simply changing the covers according to the schedule.

### SUMMARY

According to one aspect of the present technology, there is a system for determining an extent of impairment of acoustic transmissivity of a structural arrangement exposing a microphone of an audio-processing device to incident sound waves, the system comprising a sound-wave source, the microphone, and a sound processor configured to receive first and second responses by the microphone responsive one or more signals emitted by the sound-wave source, and determine the extent of the impairment based on the first and second responses.

According to one aspect of the present technology, there is a method of determining an extent of impairment of acoustic transmissivity of a structural arrangement exposing a microphone, the method comprising receiving first and second responses generated by the microphone responsive to at least one of (i) a macro acoustic signal or (ii) respective separate first and second acoustic signals, and ascertaining the extent of impairment based on the first and second responses.

According to one aspect of the present technology, there is a method of determining an extent of impairment of acoustic transmissivity of a structural arrangement exposing a microphone, the method comprising receiving first and second responses generated by the microphone responsive to received acoustic energy, and ascertaining the extent of impairment based on the first and second responses.

According to one aspect of the present technology, there is provided a method of determining an extent of impairment of acoustic transmissivity of a structural arrangement exposing a microphone. Such a method comprises: receiving first and second responses by the microphone and determining the extent of impairment based on the manipulation the first and second responses. For example, a mores specific example of such a method could more specifically include: applying a test signal to a microphone covered by a cover; receiving a response of the covered microphone responsive to the acoustic test signal; processing the received response; and determining the extent of impairment based on the processing. Such processing can include, e.g., comparing the received response with at least one reference value, the reference value being indicative of the extent of impairment.

In another aspect of the present technology, there is provided a system for determining an extent of impairment of acoustic transmissivity of a structural arrangement exposing a microphone of an auditory prosthesis to incident sound waves. Such an apparatus comprises: a sound-wave source; the microphone; and a sound processor. Such a sound processor is configured to: receive first and second responses by the microphone responsive to first and second acoustic signals emitted by the sound-wave source; and determine the extent of the impairment based on the manipulation.

### BRIEF DESCRIPTION OF THE DRAWINGS

Embodiments of the present technology are described below with reference to the attached drawings, in which:

FIG. 1A illustrates a perspective view of an audio-processing device, e.g., a behind the ear (“BTE”) unit of an auditory prosthesis, in which some embodiments of the present technology may be implemented;

FIG. 1B is an exploded, perspective view of FIG. 1A;

FIG. 1C illustrates a schematic block diagram of processing unit 102 of BTE 100 of an auditory prosthesis, in which some embodiments of the present technology may be implemented;

FIGS. 2A-2C are partial cross-sectional views of example configurations of a processing unit, in which some embodiments of the present technology may be implemented, respectively;

FIG. 3A is a plot of baseline frequency responses of a microphone disposed in a port and covered by instances of an unsoiled cover;

FIG. 3B is a plot of frequency responses of the same microphone as used for FIG. 3A disposed in the port and covered by similar instances of the cover except that each instance exhibits varying degrees of blockage and/or clogging due to exposure to debris;

FIG. 4A is a flowchart illustrating a method of determining an extent of impairment of acoustic transmissivity of a structural arrangement (e.g., a port or cover arrangement) exposing a microphone of an audio-processing device (e.g., an auditory prosthesis) to incident sound waves, in accordance with some embodiments of the present technology;

FIG. 4B is a more detailed illustration of the manipulation block of the flowchart of FIG. 4A, in accordance with some embodiments of the present technology;

FIG. 4C is a more detailed illustration of the determination block of the flowchart of FIG. 4A, in accordance with some embodiments of the present technology;

FIG. 4D is a more detailed illustration of the noisy decision block of the flowchart of FIG. 4A, in accordance with some embodiments of the present technology; and

FIG. 4E is a flowchart illustrating ‘parallel’ signal emission arrangement, in accordance with some embodiments of the present technology, that represents an alternative to the sequential signal emission arrangement of blocks 404-410 of FIG. 4A.

### DETAILED DESCRIPTION

Aspects of the present technology are generally directed to determination of an extent of impairment of acoustic transmissivity of a structural arrangement (e.g., a port arrangement or cover arrangement) exposing a microphone of an audio-processing device (e.g., an auditory prosthesis) to incident, e.g., ambient, sound waves. A method of making such a determination includes: receiving a first response by the microphone to a first acoustic signal (e.g., a calibration signal including one or more frequencies for which a response by the microphone is attenuated insignificantly because of partial, though not substantially total, blockage of the structural arrangement, e.g., at about 1 kHz) emitted by a sound-wave source (e.g., the remote control unit of the audio-processing device); receiving a second response by the microphone to a second acoustic signal (e.g., a test signal including one or more frequencies for which a response thereto by the microphone is attenuated significantly by at least partial blockage of the structural arrangement, e.g., at about 6 kHz) emitted by the sound-wave source; processing or manipulating the first and second responses; and ascertaining the extent of impairment based on the manipulation. In one example ascertaining the extent of impairment can be achieved by estimating the extent of impairment based on the processing or manipulation of the first and second responses.

In regard to a policy of replacing a part or the entirety of such structural arrangements (e.g., microphone covers) according to a schedule (e.g., once every three months), and in the course of developing the present technology, the following observations were made: adhering to the schedule can suffer the ‘cost’ of replacing some impaired covers too slowly (thereby causing the recipient of the audio-processing device to experience diminished performance); adhering to the schedule can suffer the ‘cost’ of replacing some covers before their acoustic transmissivity has become significantly impaired (thereby causing the recipient to enjoy less than the full ‘lifetime’ of the covers being prematurely replaced); and, for many recipients, the opportunity costs of visiting the clinician (to check for impairment of the acoustical path) according to the schedule outweigh the noted ‘costs’ of simply replacing the covers according to the schedule. At least some aspects of the present technology permit recipients to reduce the ‘costs’ of simply replacing the covers according to the schedule without having to suffer the opportunity costs of visiting the clinician to check for impairment of the acoustical path.

FIG. 1A illustrates a perspective view of an audio-processing device 100, e.g., a behind the ear (“BTE”) unit of an auditory prosthesis, in which some embodiments of the present technology may be implemented. FIG. 1B is an exploded, perspective view of FIG. 1A.

The auditory prosthesis may be a partially implantable hybrid auditory prostheses, and may use a single mode of stimulation, or a multi-mode (e.g., dual-mode) combination of stimulation types in which the respective modes of stimulation are different. The different stimulation types (by which to evoke a hearing percept in the recipient) include, but are not limited to: optical stimulation, electrical stimulation, acoustical stimulation, middle-ear mechanical stimulation; bone-conductive mechanical stimulation, and/or other different stimulation types (by which to evoke a hearing percept in the recipient) now known or later developed.

In FIGS. 1A-1B, BTE unit 100 includes a processing unit 102, a controller 104 and an earhook 106. Processing unit 102 is removably attachable to each of controller 104 and earhook 106. Incorporated into its housing, controller 104 includes user-interface controls, e.g., actuatable buttons 108 and 110, and a display 112. Contained within the housing of processing unit 102 is circuitry (not illustrated) that includes, e.g., one or more software-controlled microprocessors and one or more memory devices that include corresponding software to operate the one or more microprocessors. Alternatively, controller 114 could take the form of body-worn module housing (containing the control circuitry) connected via a cable to a ‘shoe’ that is removably attachable to processing unit 102.

Processing unit 102 includes a housing that contains processing circuitry (not illustrated in FIGS. 1A-1B but see FIG. 1C) that, among other things, processes incident sound signals. Processing unit 102 further includes a socket 116 and ports 118, and 120 and an optional port 122 (the optional aspect being denoted by via the use of phantom lines for port 150C) that are incorporated into housing 114. Socket 116 is configured to receive a corresponding plug that terminates a cable leading to another component of the auditory prosthesis. For example, if BTE unit 100 were configured to work with a cochlear implant type of hearing prosthesis, then the component to which the plug was connected might be an external transmitter and/or transceiver unit for which the cochlear implant includes a corresponding internal receiver and/or transceiver unit, etc. Alternatively, aspects of the present technology can be used with other auditory prostheses, e.g., bone conduction devices, and more generally, audio-processing devices having one or more instances of a structural arrangement (e.g., a port arrangement or cover arrangement) exposing a microphone of an audio-processing device.

Components 118, 120 and 122 of housing 114 represent ports. Ports 118 and 120 of housing 114 represent features of a structural arrangement that exposes corresponding microphones (not illustrated in FIGS. 1A-1B but see, e.g., FIGS. 2A-2C) to incident sound waves. Processing unit 102 further includes a microphone protector 124 that includes a frame 126 having apertures corresponding to ports 118, 120 and 122, and covers 128 disposed in the apertures.

FIG. 1C illustrates a schematic block diagram of processing unit 102 of BTE 100 of an auditory prosthesis, in which some embodiments of the present technology may be implemented.

As noted above, processing unit 102 includes processing circuitry, which is illustrated as block 142 in FIG. 1C. Processing circuitry 142 includes one or more software-controlled processors 144 that, among other things, process incident sound signals, and one or more memory devices 146 that include corresponding software to operate the one or more microprocessors. Also in FIG. 1C, signal lines are illustrated as providing signals from microphones 150A-150B (of ports 118 and 120, respectively) and optional microphone 150C (of optional port 122) to processing circuitry 142.

BTE unit 100 can be configured to operate in conjunction with an optional, corresponding remote control unit 130 and/or an optional corresponding remote control application software 138 executing on a smart phone 136. Remote control unit 130 includes control circuitry (not illustrated) and an optional sound-wave source 132 (the optional aspect being denoted by via the use of phantom lines for sound-wave source 132). Remote control unit 130 is illustrated as having a connection 134 (e.g., a wireless connection) to processing unit 102. Smart phone 136 includes a sound-wave source 140. Smart phone 136 is illustrated as having a connection 141 (e.g., a wireless connection) to processing unit 102. Alternatively, processing unit 102 may be provided with an optional sound-wave source 148 (the optional aspect being denoted by via the use of phantom lines for sound-wave source 148).

Covers 128 are typically made from a porous material that is permeable to air (and thus is acoustically transmissive) but is relatively non-porous in terms of debris. The material may also be relatively non-porous in terms of non-debris liquids, e.g., water. One example of material that can be used for covers 128 is a porous form of polytetrafluoroethylene that has a micro-structure characterized by nodes interconnected by fibrils, e.g., a GORE-TEX® brand membrane thereof marketed by W. L. Gore & Associates, Inc.

FIGS. 2A-2C are partial cross-sectional views of example configurations of processing unit 102, in which some embodiments of the present technology may be implemented, respectively.

In FIGS. 2A-2C, ports 118, 120 and 122 are assumed to have substantially the same configuration. Accordingly, only one of ports 118, 120 and 122 is illustrated in each of FIGS. 2A-2C, for simplicity. Each of ports 188-122 is configured as a recess within housing 114. Located within ports 118, 120 and 122 are microphones 150A-150C, respectively, each of which includes a mechanico-electrical transducer (also referred to in the art as an electro-mechanical transducer) 152 coupled to a diaphragm 154. Alternatively, microphones 150A-150C can have different configurations and/or include different types of mechanico-electrical transducers and diaphragms. Ports 118, 120 and 122 are provided with covers 128A-128C as discussed in more detail below, respectively. It is further assumed that covers 128A-128C acoustically seal ports 118, 120 and 122 against the incident environment such that substantially all of the incident sound signals that reach microphones 150A-150C have travelled an acoustic signal path passing through covers 128A-128C, respectively.

In FIG. 2A, frame 126A of microphone protector 124A includes apertures that are wider than the recess of ports 118, 120 and 122 such that cover 128A is wider than ports 118, 120 and 122. Cover 128A is substantially the same thickness as frame 128 and so cover 128A does not extend down into ports 118, 120 and 122.

In FIG. 2B, frame 126B of microphone protector 124B includes apertures that are substantially the same width as the recess of ports 118, 120 and 122 such that cover 128B is substantially the same width as ports 118, 120 and 122. Cover 128BA is significantly thicker than frame 128B and so cover 128A extends down into ports 118, 120 and 122.

In FIG. 2C, frame 126C of microphone protector 124C includes apertures that are wider than the recess of ports 118, 120 and 122 such that a portion of cover 128C is wider than ports 118, 120 and 122. A portion of cover 128C is significantly thicker than frame 128C and so a portion of cover 128C extends down into ports 118, 120 and 122.

In each of FIGS. 2A-2C, covers 128A-128C are illustrated as fitting flush with an external surface of frames 126A-126C, respectively. Alternatively, other types of fit between the covers and the frames can be implemented.

The acoustic transmissivity of ports 118, 120 and 122 typically becomes impaired due to covers, e.g., 128, becoming progressively more contaminated with debris, i.e., becoming progressively more blocked and/or clogged. In other words, as the covers 128 degrade over time, they transmit less acoustic information (e.g., incoming or incident sound waves) to the microphones. The greater the degradation, the increased reduction in sound transmission to the microphones. For auditory prostheses such as BTE unit 100, common types of debris that contaminate covers 128 are cosmetics (e.g., hairspray) and sebum. Sebum is an oily or waxy substance secreted by mammalian sebaceous glands in the skin whose purpose is to lubricate and waterproof the skin and hair. Sebum includes wax, triglyceride oils, squalene, and metabolites of fat-producing cells.

Each of microphones 150A-150C that is disposed in respective ports 118, 120 and 122 covered by unsoiled covers, e.g., 128, will exhibit a baseline frequency response. FIG. 3A is a plot of baseline frequency responses of a given one microphones 150A-150C, e.g., 150A, disposed in port 118, covered by six instances of unsoiled cover 128 made from the noted porous form of polytetrafluoroethylene. Inspection of FIG. 3A reveals: across the six plots, amplitude varies by about 2 dB; each plot exhibits a peak at about 6.5K Hz; and each plot exhibits significant attenuation at frequencies below about 100 Hz.

FIG. 3B is a plot of frequency responses of microphone 150A disposed in port 118 covered by similar instances of cover 128 that are made from the noted porous form of polytetrafluoroethylene but which exhibit varying degrees of blockage and/or clogging due to exposure to debris, for example, cosmetics and sebum.

In FIG. 3B, at or below about 3K Hz and down to about 100 Hz, the frequency responses for covers 128 that have varying degrees of partial, albeit not substantially total, blockage and/or clogging exhibit relatively insignificant attenuation in terms of amplitudes for corresponding frequencies in FIG. 3A. Above about 3K Hz, however, the frequency responses in FIG. 3B for covers 128 that have varying degrees of partial, albeit not substantially total, blockage and/or clogging exhibit relatively significant attenuation in terms of amplitudes for corresponding frequencies in FIG. 3A. For example, attenuation of about 5 dB or greater represents significant attenuation. Attenuation of about 5 dB or greater would result, e.g., in distorted maxima selection by processing unit 102 (which would be perceived by the recipient, e.g., as increased difficulty in hearing higher frequency sounds such as speech by a child), and/or in distorted directionality by processor unit 102 such as processor unit 102 changing the direction of beam-forming in a circumstance that the microphone covers exhibit disparate levels of clogging, etc. In FIG. 3B, uniform blockage and/or clogging of covers 128 of ports 118, 120 and 122 has been assumed. It is noted that distortions in directionality would also be adversely affected by non-uniform blockage and/or clogging of covers 128 of ports 118, 120 and 122.

In the course of developing the present technology, the contrast between FIG. 3A and FIG. 3B, among other things, led to the following observations: a significant impact of impairment of acoustic transmissivity of a structural arrangement (e.g., a port or cover arrangement) exposing a microphone of an audio-processing device (e.g., an auditory prosthesis) to incident sound waves over time is the phenomenon of increasing attenuation of the frequencies in the range of frequencies corresponding to the peak in the baseline frequency response; a further phenomenon is that attenuation at low frequencies is relatively unchanged until there is significant blockage; and a consequence of these phenomena, in the context of an auditory prosthesis, is that the acoustic levels on a maxima selected channel progressively decrease, resulting (under some circumstances) in a selection of a different maxima channel.

At least some aspects of the present technology provide a method of determining an extent of impairment of acoustic transmissivity of a structural arrangement exposing a microphone of an audio-processing device to incident sound waves by assessing attenuation of the frequencies in the range of frequencies corresponding to the peak in the baseline frequency response of a one or more of the microphones disposed in the ports relative to the amplitudes of the corresponding frequencies in the baseline frequency response.

FIG. 4A is a flowchart 400 illustrating a method of determining an extent of impairment of acoustic transmissivity of a structural arrangement (e.g., a port or cover arrangement) exposing a microphone of an audio-processing device (e.g., an auditory prosthesis) to incident sound waves, in accordance with some embodiments of the present technology.

It is assumed that the method of flowchart 400 will be executed in relatively quiet conditions. In FIG. 4A, flow begins at block 402 and proceeds to decision block 403, where it is decided whether the incident environment is too noisy to continue with determining the extent of impairment of acoustic transmissivity of a structural arrangement. For example the ambient environment noise should be less than about 60 dBA, but more preferably less than about 50 dBA. If so, i.e., if the incident environment is too noisy (e.g., noise is greater than about 60 dBA), then flow proceeds to block 468, where flow ends. If not, i.e., if the incident environment is not too noisy, then flow proceeds to block 404. Incident noise decision block 403 is illustrated in more detail in FIG. 4D, which is discussed below.

At block 404, acoustic energy in the form of a first acoustic signal, sⱼ, is emitted by a designated sound-wave source, e.g., 132, 140 or 148. For example, the first acoustic signal sⱼ, may be a calibration signal including, e.g., one or more frequencies in a relatively narrow bandwidth for which response thereto by microphone is attenuated insignificantly by partial, albeit not substantially total, blockage) of the structural arrangement, e.g., cover 128. In one example the first acoustic signal should be greater than 65 dB SPL in amplitude.

From block 404, flow proceeds to block 406, where a first response to the first acoustic signal sⱼ, is received from one or more microphones, e.g., one or more of microphones 150A and 150B (and/or 150C, if optionally present, as noted above), e.g., by processing circuitry 142 of processing unit 102. That is, for a given acoustic signal from a sound-wave source, the responses from microphones 150A-150C are independent and are received substantially concurrently. As such, responses from each of microphones 150A-150C can be received substantially concurrently at block 406. From block 406, flow proceeds to block 408.

At block 408, acoustic energy in the form of a second acoustic signal, sₖ, is emitted by the designated sound-wave source. For example, the second acoustic signal sₖ may be a testing signal including, e.g., one or more frequencies in a relatively narrow bandwidth for which a response thereto by the microphone is attenuated significantly by at least partial blockage of the structural arrangement. Alternatively, order of emitting the acoustic signals could be reversed, namely the test signal could be emitted in block 404 as the first acoustic signal sⱼ and the calibration signal could be emitted in block 408 as the second acoustic signal sₖ. Indeed, as will be further disclosed below, in an alternative embodiment, the emitted acoustic signals could be emitted simultaneously (e.g., via a macro-signal). By way of example only and not by way of limitation, the starting times of the first and second acoustic signals can coincide with one another. Alternatively and/or in addition to this, the temporal periods over which the respective acoustic signals are emitted can overlap one another (e.g. the starting times of the first and second acoustic signals can be the same and/or can be different, providing that the latter emitted acoustic signal begins its emission during emission of the former acoustic signal). In an exemplary embodiment, the macro signal can be a signal that changes with time (e.g., it starts with the first signal and then the second signal begins at a time after the start of the first signal, or visa-versa, etc.) Together, the first acoustic signal sⱼ (block 404) and the second acoustic signal sₖ (block 408) represent a set of acoustic signals, setᵢ (see discussion below). From block 408, flow proceeds to block 410, where a second response to the second acoustic signal sₖ is received from the one or more microphones, e.g., by processing circuitry 142 of processing unit 102. Again, for a given acoustic signal from a sound-wave source, the responses from microphones 150A-150C are independent and are received substantially concurrently. As such, responses from each of microphones 150A-150C can be received at block 410. From block 410, flow proceeds to block 420.

At block 420, the first and second responses for respective microphones are manipulated, e.g., by processing circuitry 142 of processing unit 102 in terms of an i^{th} signal set. From block 420, flow proceeds to block 430, where an extent of impairment of the acoustic transmissivity of the structural arrangement corresponding to the respective microphone is determined based on the manipulation of block 420. From block 430, flow proceeds to decision block 440, where it is decided whether each cover is sufficiently soiled such that replacement is warranted. If so, i.e., if the replacement of a given cover is warranted, then flow proceeds from decision block 440 to block 450, where replacement of the given cover is indicated to the user of the method, e.g., the recipient of the auditory prosthesis. From block 450, flow proceeds to decision block 460. If not, i.e., if the replacement of the given cover is not warranted, then flow proceeds from decision block 440 directly to decision block 460.

The method of flowchart 400 can be iterative. For each iteration, one or both of the first acoustic signal sⱼ and the second acoustic signal sₖ will be different. For a given iteration, the first acoustic signal sⱼ (block 404) and the second acoustic signal sₖ (block 408) represent (as mentioned above) an i^{th} set of acoustic signals, setᵢ. The decision to iterate flowchart 400 is made at decision block 460.

At decision block 460, it is decided whether to iterate, i.e., whether processing for another set of acoustic signals is to be carried out. If so, i.e., if another set of acoustic signals, setᵢ₊₁, is to be processed, then flow proceeds to block 462, where the set of acoustic signals is changed from setᵢ. to setᵢ₊₁.

From block 462, flow proceeds by looping back to block 404. If not, i.e., if no other signal sets are to be processed, then flow proceeds to block 460, 468, where flow ends. As noted above, for each iteration, one or both of the first acoustic signal sⱼ and the second acoustic signal sₖ will be different.

Blocks 430-462 can be executed solely by processing unit 102, remote control unit 130 or remote control application software 138 executing on smart phone 136. Alternatively, execution of blocks 430-462 can be divided amongst processing unit 102, remote control unit 130 and/or remote control application software executing on smart phone 136.

Alternatively, for example, recalling that the structural arrangement has an initial extent of impairment represented by a baseline frequency response profile, the calibration signal emitted at block 404 may include one or more frequencies located in a substantially flat region of the baseline frequency response profile, and the testing signal may include one or more frequencies located in a substantially peaked region of the baseline frequency response profile.

Also, alternatively, if the frequency response of the sound-wave source can be assumed to be stable over time, then blocks 404 and 406 could be performed once and the first response stored in memory (e.g., memory 146) for use by block 420. For example, blocks 404 and 406 could be carried out as steps in the manufacture of BTE 100, or could be carried out the first time that the method is executed but not again thereafter unless there is a change in the sound-wave source and/or one or more of microphones 150A-150C.

Emission of the first acoustic signal at block 404 can be regarded as occurring while the sound-wave source is disposed at a given position in three-dimensional space proximal to the structural arrangement, more specifically at the given position proximal to the microphone. If the emission of the second acoustic signal at block 408 occurs after the sound-wave source has changed its proximity with respect to the structural arrangement, more specifically, with respect to the microphone, then the second response will reflect not only what, if any, impairment of acoustic transmissivity exists, but likely will also exhibit distortion due to a different sound path to the microphone. If, however, the second acoustic signal is emitted while the sound-wave source remains disposed in substantially the same proximity with the respect to the structural arrangement as the given position, then distortion due to a different signal path can be reduced, if not minimized.

Emission of the first acoustic signal at block 404 can be regarded as occurring while the sound-wave source is disposed at a given orientation (e.g., facing towards the microphones, facing away, etc.) with respect to the structural arrangement, more specifically at the given orientation with respect to the microphone. In one example, the emission of at least the first acoustic signal should be conducted from a distance of about 25 cm or less from the structural arrangement. If the emission of the second acoustic signal at block 408 occurs after the sound-wave source has changed its orientation with respect to the structural arrangement, more specifically, with respect to the microphone, then the second response will reflect not only what, if any, impaired acoustic transmissivity exists, but likely will also exhibit distortion due to a different sound path to the microphone. If, however, the second acoustic signal is emitted while the sound-wave source remains disposed in substantially the same orientation with the respect to the structural arrangement as the given orientation, then distortion due to a different signal path can be reduced, if not minimized. In another example, the emission of the first and second acoustic signals should be conducted from a distance of about 25 cm or less from the structural arrangement.

One of the ways in which to locate the sound-wave source in space relative to the structural arrangement, more specifically relative to the microphone, is by manual dexterity. In other words, the recipient holds the sound-wave source close to BTE unit 100. Manual dexterity, however, can be subject to significant variation in location and/or orientation relative to the given location in space, i.e., significant location tolerance and/or significant orientation tolerance, the consequence of which can be different acoustic paths to the microphone for the first and second acoustic signals. In some instances, emitting the first and second acoustic signals too close in time to each other may result in undesirable overlap of the two signals, e.g., reverberation. If, however, the second acoustic signal is emitted by the sound-wave source sufficiently far apart in time to relative to the emission time of the first acoustic signal, then temporal overlap in the emission of the first and second signals can be substantially avoided. That said, in other instances, there is little and/or no deleterious effects of emitting the first and second acoustic signals at the same time (including an overlapping manner with different start and/or end times, and thus, in at least some embodiments, the teachings detailed herein and/or variations thereof can be practiced without temporal restrictions vis-à-vis the first and second acoustic signals (e.g., they are emitted at the same time or at different times). Still, in embodiments where the second acoustic signal is emitted at a second emission time by the sound-wave source sufficiently close in time to the first emission time, then effects upon the second response that otherwise would be due to the sound-wave source having been moved to a second position and/or orientation different than the given position and/or orientation can be substantially avoided, at least in some instances where such effects result in a deleterious effect. Of course, as noted above, in at least some instances, there are no effects (or at least no effectively deleterious effects or at least no effects that detract from the utility of practicing the teachings detailed herein and/or variations thereof) upon the second response vis-a-vis the temporal relationships between the first and second acoustic signals (e.g., and thus any of the effects associated with sound-wave source having been moved to a secondposition and/or orientation different than the given position/orientation are deminimis, if existent at all). In at least some embodiments, any temporal and/or spatial relationship between the first and second acoustic signals that can enable the teachings detailed herein and/or variations thereof to be practiced can be utilized in at least some embodiments.

FIG. 4B is a more detailed illustration of block 420 of flowchart 400 (of FIG. 4A), in accordance with some embodiments of the present technology.

Block 420 of FIG. 4B includes a block 421, in which a figure of merit (“FOM”) is determined. Flow proceeds in block 421 to a block 422, where Resp(sⱼ) and Resp(sₖ) are determined, where Resp(sⱼ) is, e.g., a representative amplitude (e.g., a peak amplitude) for the first response relative to the frequency band of the first acoustic signal sⱼ, and Resp(sₖ) is, e.g., a representative amplitude (e.g., a peak amplitude) for the second response relative to the frequency band of the second acoustic signal sₖ. The FOM can be based, e.g., on a difference and/or a quotient. From block 422, flow proceeds to one or more (in parallel) of blocks 423, 424 and 425.

At block 423, a first difference δ (setᵢ) is calculated, e.g., as follows:

δ(setᵢ)=Resp(sⱼ)−Resp(sₖ) (1)

where setᵢ represents an i^{th} set of acoustic signals of interest (namely sⱼ and sₖ.

At block 424, a first quotient ρ(setᵢ) is calculated, e.g., as follows:

$$ρ ( {set}_{i} ) = \frac{Resp ( {s}_{k} )}{Resp ( {s}_{j} )} \qquad ( 2 )$$

At block 425, Resp(Sⱼ) is used to index a mapping, namely Mapping_Unclogged(Sⱼ) that has been stored in memory (e.g., memory 146). For a given sound-wave source emitting a given acoustic signal, the magnitude of a corresponding response signal generated by a microphone depends, at least in part, on the distance between the sound-wave source and the microphone. Attenuation in the response signal is distance dependent, i.e., attenuation increases as distance increases. Distance-dependent attenuation also exhibits variation according to frequency. That is, distance-dependent attenuation is also frequency dependent. For substantially unclogged conditions, Mapping_Unclogged(Sⱼ) maps values of Resp(Sⱼ) to values of distance, D, from the sound source to the microphone, and to values of frequency, f, i.e., Mapping_Unclogged(Sⱼ)={D:Resp(Sⱼ):f}. At block 425, by indexing into mapping Mapping_Unclogged(Sⱼ) using Resp(Sⱼ) and the frequency band of (Sⱼ), a value for the distance corresponding to Resp(Sⱼ) can be obtained. Flow proceeds from block 425 to a block 426. Similarly, for substantially unclogged conditions, Mapping_Unclogged(Sₖ) maps values of Resp(Sₖ) to values of distance, D, and to values of frequency, f, i.e., Mapping_Unclogged(Sₖ)={D:Resp(Sₖ):f}. Likewise, Mapping_Unclogged(Sₖ) can be stored in memory (e.g., memory 146). At block 426, the value of D obtained in block 425 and the frequency band of (Sₖ) are used to index into mapping Mapping_Unclogged(Sₖ) in order to obtain a predicted value of the response to the second acoustic signal Sₖ, namely Predict(Sₖ). From block 426, flow proceeds to one or both (in parallel) of blocks 427 and 428.

At block 427, a second difference ε(setᵢ) is calculated, e.g., as follows:

ε(setᵢ)=Predicted(sₖ)−Resp(sₖ) (1)

At block 428, a second quotient σ(setᵢ) is calculated, e.g., as follows:

$$σ ( {set}_{i} ) = \frac{Resp ( {s}_{k} )}{Predict ( {s}_{k} )} \qquad ( 2 )$$

To summarize, the FOM can be based one or more or the first and second differences and the first and second quotients. Accordingly, flow proceeds from each of blocks 423, 424, 427 and 428 to block a block 429, where the FOM is calculated as follows.

FOM(setᵢ)=f(δ(setᵢ),ρ(setᵢ),ε(setᵢ) and/or σ(setᵢ)) (3)

FIG. 4C is a more detailed illustration of block 430 of flowchart 400 (of FIG. 4A), in accordance with some embodiments of the present technology.

Block 430 of FIG. 4C includes alternative first and second paths, the first path including block 432, and the second path including blocks 434 and 436. For the first path, at block 432, FOM(setᵢ) is compared against a first threshold TH1. Accordingly, if decision block 440 is reached via the first path of block 430, then a value of FOM(setᵢ) exceeding TH1 will warrant replacement of the cover. For the second path, at block 434, the value of FOM(setᵢ) is indexed into a lookup table (“LUT”) and/or array that relates values of FOM(setᵢ) to extents or degrees of impairment of transmissivity, e.g., percentages of blockage. Flow proceeds from block 434 to block 436, where blockage(setᵢ) is compared against a second threshold, TH2. Accordingly, if decision block 440 is reached via the second path of block 430, then a value of blockage(setᵢ) exceeding TH2 will warrant replacement of the cover.

FIG. 4D is a more detailed illustration of incident noise decision block 403 of flowchart 400 (of FIG. 4A), in accordance with some embodiments of the present technology.

Within incident noise decision block 403, flow proceeds to block 470, where a preliminary response by one or more of microphones 150A-150C to incident sound waves is received. It is has been determined that a noisy incident environment substantially reduces the accuracy of the determined impairment of acoustic transmissivity of the structural arrangement. Flow proceeds from block 470 to block 472, where one or more of the preliminary responses is/are compared to a noise threshold, THN, respectively. Flow proceeds from block 472 to decision block 474, where it is decided whether the preliminary response exceeds the noise threshold THN. If so, i.e., if the noise threshold THN has been exceeded, then flow proceeds to block 468, where flow ends. If not, i.e., if the noise threshold THN has not been exceeded, then flow proceeds to block 404. Alternatively, if it is desired to account for the possibility that high levels of incident noise are transient, then flow can proceed from block 474 and loop back to block 470 for a desired interval. At the end of the desired interval, if the incident noise still exceeds the noise threshold, THN, then flow can proceed from block 474 to block 468, where flow ends. Alternatively, block 403 can be located between blocks 420 and 430 rather than between blocks 402 and 404. Also, alternatively, another instance of block 403 can be provided between blocks 420 and 430.

Blocks 404-410 of flowchart 400 of FIG. 4A assume the use of a sound-wave source that is capable of concurrently reproducing a relatively small bandwidth of frequencies substantially without exhibiting significant acoustic distortion, but which is incapable of concurrently reproducing a relatively large bandwidth of frequencies without exhibiting significant acoustic distortion for a least a portion of the relatively large bandwidth. Such a sound-wave source can be, e.g., a buzzer or a relatively low fidelity loudspeaker and hereinafter will be referred to as a low-fi sound-wave source. Because of the acoustic distortion that would result if it were attempted to reproduce a relatively large bandwidth signal using the low-fi sound-wave source, reproduction of the first acoustic signal sⱼ and reproduction of the second acoustic signal sₖ are performed sequentially, i.e., the first acoustic signal sⱼ is emitted at block 404, the first response is received at block 406, the second acoustic signal sₖ is emitted at block 408, and the second response is received at block 410.

An advantage of the sequential signal emission of blocks 404-410 is that, e.g., the low-fi sound-wave source and the associated circuitry to drive the same are less expensive than relatively high-fidelity counterparts. Another advantage of the sequential signal emission is that, e.g., it is easier to detect if the response to one or both of the first acoustic signal sⱼ and the second acoustic signal sₖ is contaminated with incident noise. For example, optionally at block 406, amplitude levels of the first response for frequencies outside the relatively narrow bandwidth of the first acoustic signal sⱼ, can be compared against a noise threshold, e.g., THN, and a decision made whether the incident noise exceeds the noise threshold THN, etc., e.g., in a manner similar to that illustrated in FIG. 4D and discussed above. Similar optional processing can be conducted at block 410 for the second response relative to the relatively narrow bandwidth of the first acoustic signal sₖ.

Alternatively, instead of a sequential signal emission as in blocks 404-410 of FIG. 4A, a ‘parallel’ signal emission can be provided, e.g., in terms of blocks 505-507 of FIG. 4E.

FIG. 4E is a flowchart illustrating a ‘parallel’ signal emission arrangement, in accordance with some embodiments of the present technology, that represents an alternative to the sequential signal emission arrangement of blocks 404-410 of FIG. 4A. As discussed above, blocks 404-410 can be described as a sequential signal emission. As will be explained below, blocks 505-507 can be described as a ‘parallel’ signal emission.

Blocks 505-507 assume the use of a sound-wave source that is capable of concurrently reproducing a relatively large bandwidth of frequencies without exhibiting significant acoustic distortion across the relatively large bandwidth. Such a sound-wave source can be, e.g., a relatively high fidelity loudspeaker and hereinafter will be referred to as a hi-fi sound-wave source. Included within the relatively large bandwidth signal (hereinafter macro acoustic signal, s_{mac}), that can be reproduced by the hi-fi sound-wave source without exhibiting distortion are the first relatively narrow bandwidth acoustic signal sⱼ, (discussed above) and the second relatively narrow bandwidth acoustic signal sₖ (discussed above). The macro acoustic signal s_{mac} can include substantially only signals sⱼ, and sₖ (i.e., the acoustic energy received by the microphone includes only those two signals) or it can include content at other frequencies. For example, the macro acoustic signal s_{mac} can be a white noise signal that includes, among other things, content corresponding to the first signal sⱼ, and the second signal sₖ. As contrasted to a version of the macro acoustic signal s_{mac} including substantially only signals sⱼ, and sₖ, the white noise version of the macro acoustic signal s_{mac} is less susceptible to contamination due to reverberation.

In FIG. 4E, flow proceeds from block 403 to block 505, where the macro acoustic signal s_{mac} including at least content corresponding to signals sⱼ, and sₖ is emitted. Flow proceeds from block 505 to block 507, where a macro response to the macro acoustic signal s_{mac} is received from one or more microphones, e.g., one or more of microphones 150A-150C, e.g., by processing circuitry 142 of processing unit 102. As noted previously, for a given acoustic signal from a sound-wave source, the responses from microphones 150A-150C are independent and are received substantially concurrently. As such, responses from each of microphones 150A-150C can be received substantially concurrently at block 507. At block 507, the macro response (to the macro acoustic signal s_{mac}) includes a first response to the first acoustic signal sⱼ, and a second response to the second acoustic signal sₖ. From block 507, flow proceeds to block 410.

In FIG. 4E, block 505 corresponds to the sequential blocks 404 and 408 of FIG. 4A, while block 507 corresponds to the sequential blocks 406 and 410 of FIG. 4A. Though flow proceeds sequentially from block 505 to block 507, nonetheless, block 505 can be described as being akin to executing blocks 404 and 408 in parallel, and block 507 can be described as being akin to executing blocks 406 and 410 in parallel. Accordingly, blocks 505-507 can be described as representing ‘parallel’ signal emission in contrast to the sequential signal emission of blocks 404-410.

Like the sequential signal emission, the parallel signal emission can include a determination of whether the macro response to one or both of the first acoustic signal sⱼ and the second acoustic signal sₖ is contaminated with incident noise. For example, optionally at block 507, amplitude levels of the macro response for frequencies outside the relatively narrow bandwidth of the first acoustic signal sⱼ, and for frequencies outside the relatively narrow bandwidth of the first acoustic signal sₖ, can be compared against a noise threshold, e.g., THN, and a decision made whether the incident noise exceeds the noise threshold THN, etc., e.g., in a manner similar to that illustrated in FIG. 4D and discussed above. It is noted that in at least some embodiments, the input signal is only into bands and not in all frequency bands. In at least some embodiments, the frequencies of the first acoustic signal and/or the second acoustic signal can be broader than the just-detailed narrow bandwidths. Also, it is noted that the frequencies of the first acoustic signal and/or the second acoustic signal can be broken up into sub frequencies that can be separated by intervening frequencies. By way of example only and not by way of limitation, the frequencies of the first acoustic signal can correspond to frequencies from “W” Hz to “X” Hz and from “Y” Hz to “Z” Hz with a gap between frequency “X” and frequency “Y”. Further by way of example only and not by way of limitation, the frequencies of the first acoustic signal can correspond to frequencies from “w” Hz to “x” Hz and from “y” Hz to “z” Hz with a gap between frequency “x” and frequency “y”. In at least some embodiments, there are additional bands that make up the first acoustic signal and/or the second acoustic signal. Any arrangement of frequency bands that can enable the teachings detailed herein and/or variations thereof to be practiced can utilize in at least some embodiments.

In at least some embodiments, there is utilitarian value in parallel signal emission in that the method illustrated by the flowchart of FIG. 4E is relatively faster to execute than the sequential signal emission method illustrated by the flowchart of FIG. 4A. As such, the burden to maintain conditions that achieve relatively low incident noise does not last as long for parallel signal emission as for sequential signal emission. Alternatively and/or in addition to this, in at least some embodiments, there is utilitarian value in that with simultaneous signals, issues pertaining to orientation and distance can be disregard. By way of example only and not by way of limitation, in at least some exemplary embodiments, the issues pertaining to orientation and/or distance can be disregarded because the signals are processed simultaneously. That said, in alternate embodiments, the issues pertaining to orientation and/or distance can be disregarded for other reasons.

Regarding the degree of difficulty of recognizing incident noise in the response by the microphone, the sequential signal emission is relatively easier than the parallel signal emission. Nevertheless, recognition of noise contamination in the macro response to the macro acoustic signal smac can be performed in a manner similar to that discussed above regarding sequential signal emission. As between first and second versions of the macro acoustic signal s_{mac}, the first version including substantially only signals sⱼ, and sₖ, the second version being a white noise version that includes not only signals sj and sk but also other substantive signal content, it is relatively easier to recognize noise in the macro response to the first version than in the macro response to the second version. FIG. 4B illustrates one exemplary processing method that is applied at block 420 by the processing unit 102. It should be understood that other processing methods that yield similar results can be utilized at block 420 by processing unit 102. It should further be understood that other alternative processing methods that yield information indicative of the extent of impairment or processing methods that yield results that can be used to determine the extent of impairment are also contemplated and can be used at block 420 by processing unit 102.

At least some aspects of the present technology permit recipients to reduce the ‘costs’ of simply replacing the covers according to the schedule without having to suffer the opportunity costs of visiting the clinician to check for impairment of the acoustical path, and do so in a simple manner, at a time and place selected by the user and/or recipient without having to purchase any additional equipment and/or provide an anechoic chamber. In other words, at least some aspects of the present technology permit recipients to reduce the ‘costs’ of simply replacing the covers according to the schedule and do so using the standard equipment that is included with the auditory processing device.

The present technology described and claimed herein is not to be limited in scope by the specific example embodiments herein disclosed, since these embodiments are intended as illustrations, and not limitations, of several aspects of the present technology. Any equivalent embodiments are intended to be within the scope of the present technology. Indeed, various modifications of the present technology in addition to those shown and described herein will become apparent to those skilled in the art from the foregoing description. Such modifications are also intended to fall within the scope of the appended claims.

What is claimed is:

1. A method of determining an extent of impairment of acoustic transmissivity of a structural arrangement exposing a microphone, the method comprising:
receiving first and second responses generated by the microphone responsive to received acoustic energy; and
ascertaining the extent of impairment based on the first and second responses.

2. The method of claim 1, wherein:
the received acoustic energy includes a calibration component and a testing component; and
the first and second responses generated by the microphone are respectively responsive to the calibration component and the testing component.

3. The method of claim 2, wherein:
the structural arrangement has an initial extent of impairment represented by a baseline frequency response profile;
the calibration signal includes one or more frequencies located in a substantially flat region of the baseline frequency response profile; and
the testing signal includes one or more frequencies located in a substantially peaked region of the baseline frequency response profile.

4. The method of claim 1, wherein:
the acoustic energy includes one or more first frequencies for which the microphone response is attenuated insignificantly by partial, albeit not substantially total, blockage of the structural arrangement;
the acoustic energy includes one or more second frequencies for which the microphone response is attenuated significantly by at least partial blockage of the structural arrangement; and
the first and second responses are respectively generated by the microphone response to the first and second frequencies.

5. The method of claim 1, wherein:
the ascertaining includes manipulating the first and second responses.

6. The method of claim 5, wherein:
the manipulating includes:
determining a test value of a figure of merit (FOM) based on the first and second microphone responses; and
the ascertaining includes:
comparing the test value of the FOM against one or more reference values.

7. The method of claim 6, wherein:
the received acoustic energy has first and second frequency bands of interest, respectively; and
the determining includes:
obtaining a first representative amplitude for the first frequency band of the first response;
obtaining a second representative amplitude for the second frequency band of the second response;
calculating at least one of a difference or a quotient based on the first and second representative amplitudes; and
calculating the FOM based on at least one of the difference or the quotient.

8. The method of claim 7, wherein:
the acoustic energy is generated by a sound-wave source; and
the calculating at least one of a difference or a quotient includes:
determining a distance between the sound-wave source and the microphone based on the first representative amplitude for the first frequency band of the first response;
determining a predicted amplitude for the second frequency band of the second response based on the distance; and
forming the at least one of the difference or the quotient based on the predicted amplitude and second representative amplitude.

9. The method of claim 6, wherein:
the one or more reference values are degrees of impairment of the acoustic transmissivity; and
the ascertaining further includes:
providing an array of information that relates example values of the FOM to different degrees of impairment;
indexing the test value of the FOM into the array in order to obtain a corresponding degree of impairment; and
treating the corresponding degree of blockage as the determination of impairment.

10. The method of claim 9, wherein:
the providing, the indexing and the treating are performed by a remote control unit corresponding to the microphone; and
the determining the test value and the comparing the test value are performed by the main unit.

11. The method of claim 1, wherein:
the microphone is mounted on a main unit that is part of an auditory prosthesis and a corresponding remote control unit; and
the method further comprises:
using the remote control unit as a sound wave source to thereby generate the acoustic energy.

12. The method of claim 11, wherein:
the remote control unit is a smartphone that includes corresponding executable remote control application software.

13. A method of determining an extent of impairment of acoustic transmissivity of a structural arrangement exposing a microphone, the method comprising:
receiving first and second responses generated by the microphone responsive to at least one of (i) a macro acoustic signal or (ii) respective separate first and second acoustic signals; and
ascertaining the extent of impairment based on the first and second responses.

14. The method of claim 13, wherein at least one of:
the macro acoustic signal to which the microphone is responsive is emitted from a given position proximal to the structural arrangement at least until the first and second responses are generated by the microphone; or
(i) the first acoustic signal is emitted from a given position proximal to the structural arrangement and (ii) second acoustic signal is emitted in substantially the same proximity with the respect to the structural arrangement as the given position.

15. The method of claim 13, wherein at least one of:
the macro signal to which the microphone is responsive is emitted from a given orientation with respect to the structural arrangement at least until the first and second responses are generated by the microphone; or
(i) the first acoustic signal is emitted from a given orientation with respect to the structural arrangement and (ii) second acoustic signal is emitted from substantially the same orientation with the respect to the structural arrangement.

16. The method of claim 15, wherein at least one of:
(i) the macro acoustic signal to which the microphone is responsive includes acoustic energy corresponding to that of a third acoustic signal and a fourth acoustic signal; and
the fourth acoustic signal is emitted such that a temporal period of emission thereof overlaps that of the third acoustic signal so as to substantially avoid effects upon the second response resulting from the fourth acoustic signal that otherwise would be due to the sound-wave source being in a second orientation at a latter emission time of the macro acoustic signal, the second orientation being different than an orientation at the given position at a former emission time of the macro acoustic signal, wherein the first response results from the third acoustic signal; or
(ii) the second acoustic signal is emitted such that a temporal period of emission thereof overlaps that of the first acoustic signal so as to substantially avoid effects upon the second response that otherwise would be due to the sound-wave source being in a second orientation at the emission time of the second acoustic signal, the second orientation being different than an orientation at the given position at an emission time of the first acoustic signal.

17. The method of claim 13, further comprising:
determining a noise level associated with the first and second responses;
comparing the noise level to a noise threshold; and
selectively proceeding, based on the comparison, to one of (a) the receiving first and second responses and (b) the ascertaining of impairment.

18. The method of claim 17, wherein the determining includes:
receiving, before proceeding to the receiving first and second responses, a preliminary response by the microphone to incident sound waves;
comparing the preliminary response to the noise threshold; and
selectively proceeding, based on the comparison, to the receiving first responses.

19. The method of claim 13, wherein:
the macro acoustic signal is received;
the first and second responses are included in a macro response that is responsive to the macro acoustic signal such that the first and second responses are generated substantially concurrently by the microphone.

20. The method of claim 13 wherein:
the structural arrangement includes a cover interposed between the microphone and incident sound waves; and
the method is utilized to determine extent of impairment of acoustic transmissivity of the cover to incident sound waves.

21. A system for determining an extent of impairment of acoustic transmissivity of a structural arrangement exposing a microphone of an audio-processing device to incident sound waves, the system comprising:
a sound-wave source;
the microphone; and
a sound processor configured to:
receive first and second responses by the microphone responsive one or more signals emitted by the sound-wave source; and
determine the extent of the impairment based on the first and second responses.

22. The system of claim 21, wherein:
the audio-processing device is an auditory prosthesis;
the microphone is mounted on the auditory prosthesis; and
the sound wave source is a remote control unit.

23. The system of claim 22, wherein:
the remote control unit is a smartphone.

24. The system of claim 21, wherein:
the one or more signals emitted by the sound-wave source are included as content in a relatively larger bandwidth macro acoustic signal; and
the first and second responses are included in a macro response that is responsive to the macro acoustic signal such that the first and second responses are generated substantially concurrently by the microphone.

25. The system of claim 21, wherein:
a plurality of signals are emitted at different times such that the first and second responses are received at different times.
